(19) United States
(12) Patent Application Publication
(10) Pub. No.: US 2007/0278949 A1
(43) Pub. Date: Dec. 6, 2007

(54) Organic Light Emitting Diode

(75) Inventors: Euan C. Smith, Cambridgeshire (GB); Faisal Qureshi, Manchester (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: CAMBRIDGE DISPLAY TECHNOLOGY LIMITED, Cambridgeshire (GB)

(21) Appl. No.: 10/591,363

(22) PCT Filed: Mar. 2, 2005
(86) PCT No.: PCT/GB05/00819

§ 371 Date: Aug. 24, 2007

(30) Foreign Application Priority Data
Mar. 3, 2004 (GB) 0404698.3

(51) Int. Cl. H01J 1/66

(52) U.S. Cl. 313/512

(57) ABSTRACT

An organic light emitting diode (OLED) device having at least one pixel, comprising a planar light coupling layer having a front surface and a back surface, said layer having a thickness T; a light emitting portion for each pixel, disposed on the back surface of the light coupling layer; and a microlens for each pixel, having a radius of curvature R, disposed on the front surface of the light coupling layer such that its center of curvature is within the light coupling layer, wherein the radius of curvature R and the thickness T are such that R=xT, where x has a value in the range from 0.2 to 0.8. The OLED device exhibits improved light emission through the use of the microlenses, formed in or attached to the light coupling layer, when so configured that the radius of curvature (R) to substrate thickness (T) ratio (R/T) is in the range from 0.2 to 0.8, preferably in the range from 0.45 to 0.6.

This invention relates to an organic light emitting diode (OLED) device having at least one pixel, comprising a planar light coupling layer and, for each pixel, a light emitting portion and a microlens. The component parts of the OLED device are so configured as to improve light emission from the device.

Organic light emitting diodes (OLEDs) comprise a particularly advantageous form of electro-optic display. They are bright, colorful, fast-switching, provide a wide viewing angle and are easy and cheap to fabricate on a variety of substrates. Organic (which here includes organometallic) LEDs may be fabricated using either polymers or small molecules in a range of colours (or in multi-coloured displays), depending upon the materials used. Examples of polymer-based OLEDs are described in WO 90/13148, WO 95/06400 and WO 99/48160; examples of so called small molecule based devices are described in U.S. Pat. No. 4,539,507.

OLEDs may be deposited on a substrate in a matrix of pixels to form a single or multi-colour pixellated display. A multicoloured display may be constructed using groups of red, green, and blue emitting pixels. In such displays the individual elements are generally addressed by activating row (or column) lines to select the pixels, and rows (or columns) of pixels are written to, to create a display. So-called active matrix displays have a memory element, typically a storage capacitor and a transistor, associated with each pixel whilst passive matrix displays have no such memory element and instead are repetitively scanned to give the impression of a steady image.

A typical OLED device comprises two layers of organic material, one of which is a layer of light emitting material such as a light emitting polymer (LEP), oligomer or a light emitting low molecular weight material, and the other of which is a layer of a hole transporting material such as a polythiophene derivative or a polyaniline derivative.

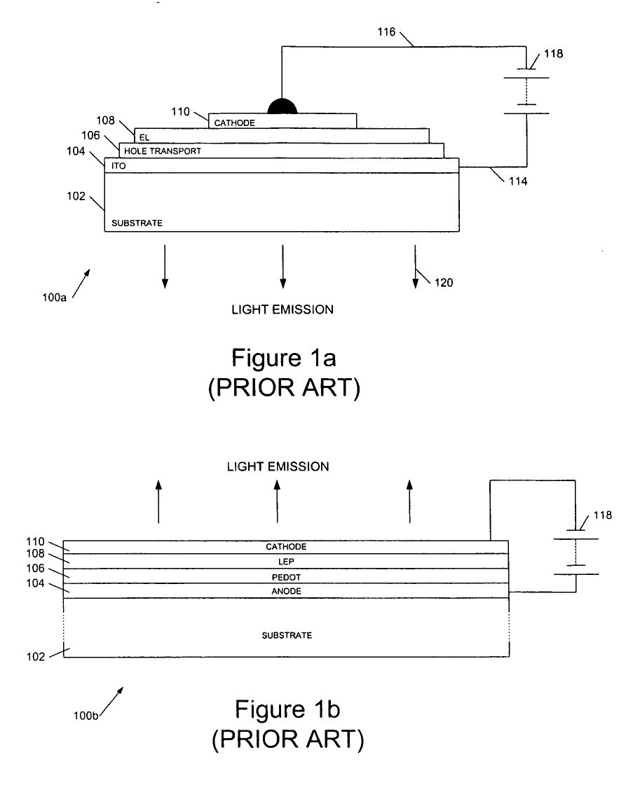

A cross-section through a basic structure of a typical OLED 100a is shown in FIG. 1a. A glass or plastic substrate 102 supports a transparent anode layer 104 comprising, for example, indium tin oxide (ITO) on which is deposited a hole transport layer 106, an electroluminescent layer 108, and a cathode 110. The electroluminescent layer 108 may comprise, for example, a PPV (poly(p-phenylenevinylene)) and the hole transport layer 106, which helps match the hole energy levels of the anode layer 104 and electroluminescent layer 108, may comprise a conductive transparent polymer, for example PEDOT:PSS (polystyrene-sulphonate-doped polyethylene-dioxythiophene) from Bayer AG of Germany. Cathode layer 110 typically comprises a low work function metal such as calcium or barium and may include an additional layer immediately adjacent electroluminescent layer 108, such as a layer of lithium fluoride, for improved electron energy level matching. Contact wires 114 and 116 to the anode and the cathode respectively provide a connection to a power source 118. The same basic structure may also be employed for small molecule devices.

In general, OLEDs consist of a multi-layer sandwich of indium-tin-oxide (ITO) as anode contact, one or more organic layers including a light emitting polymer (LEP) layer, and a metal layer as cathode, deposited on a planar substrate, usually of glass or a high refractive index plastic such as polycarbonate. In so-called “bottom emitter” devices, the multi-layer sandwich is deposited on the front surface of a planar glass substrate, with the reflecting electrode layer, usually the cathode, furthest away from the substrate, whereby light generated internally in the LEP layer is coupled out of the device through the substrate. An example of a bottom emitter 100a is shown in FIG. 1a, where light 120 is emitted through transparent anode 104 and substrate 102 and the cathode 110 is reflective. Conversely, in a so-called “top emitter”, the multi-layer sandwich is disposed on the back surface of the substrate 102, and the light generated internally in the LEP layer 108 is coupled externally through a transparent electrode layer 110 without passing through the substrate 102. An example of a top emitter 100b is shown in FIG. 1b. Usually the transparent electrode layer 110 is the cathode, although devices which emit through the anode may also be constructed. The cathode layer 110 can be made substantially transparent by keeping the thickness of cathode layer less than around 50-100 nm, for example.

In bottom emitter devices, typically only about 30% of light internally generated is emitted through the substrate-air interface, the remainder being trapped and absorbed within the substrate, e.g. 50%, and the light emitting multi-layer sandwich, e.g. 20%. As is known, this loss in light coupling efficiency arises primarily because light is wave-guided, scattered and reflected internally at the layer interfaces, as a result of the different refractive indices exhibited by the different materials forming the layers of the device.

Attempts have been made to improve the coupling efficiency, by affording the back side of the substrate with a non-planar profile, or by attaching microlenses, in order to extract more light from the substrate. For example, WO 01/33598 discloses patterning the back side of the substrate in the shape of a sphere centered on the multi-layer light source, by attaching a sphere to the back surface of the substrate or by shaping the back surface of the substrate into a spherical form. Thus, some of the generated light that would otherwise be reflected internally at the substrate-air interface can escape the substrate, thereby increasing the amount of light emitted from the device.

According to WO 01/33598, the total emitted light can be increased by a factor of up to 3, and the normal emitted light can be increased by a factor of nearly 10, through the use of spherical lenses of various radii of curvature on glass or polycarbonate substrates of various thicknesses. The disclosed lenses used have a radius of curvature (R) to substrate thickness (T) ratio (R/T) in the range from 1.4 to 4.9. Similarly, JP-A-9171892 discloses that light emission from the substrate can be increased by the use of spherical lenses on the substrate in which the radius of curvature (R) to substrate thickness (T) ratio (R/T) is about 3.6.

We have now found that improvements in light emission, in particular in luminous intensity, from an OLED device can be achieved by the use of spherical microlenses formed in or attached to the substrate, at the surface thereof defining the substrate-air interface, that are so configured that the radius of curvature (R) to substrate thickness (T) ratio (R/T) is in the range from 0.2 to 0.8. Thus, the perceived brightness to a viewer can be increased, particularly when the device is viewed from an angle at, or close to, normal with respect to the substrate.

Accordingly, the present invention provides an OLED device having at least one pixel, comprising:
a planar light coupling layer having a front surface and a back surface, said layer having a thickness T;
a light emitting portion for each pixel, disposed on the back surface of the light coupling layer; and
a microlens for each pixel, having a radius of curvature R, disposed on the front surface of the light coupling layer such that its centre of curvature is within the light coupling layer,
   wherein the radius of curvature R and the thickness T are such that R=xT, where x has a value in the range from 0.2 to 0.8.

In a first aspect, the OLED device is a bottom emitter in which the light coupling layer is a planar substrate. In this first aspect, the OLED device comprises:
a planar substrate having a front surface and a back surface, said substrate having a substrate thickness T;
a light emitting portion for each pixel, disposed on the back surface of the substrate; and
a microlens for each pixel, having a radius of curvature R, disposed on the front surface of the substrate such that its centre of curvature is within the substrate, wherein the radius of curvature R and the substrate thickness T are such that R=xT, where x has a value in the range from 0.2 to 0.8.

In a second aspect, the OLED device is a top emitter in which the light coupling layer is an encapsulating layer. In this second aspect, the OLED device comprises:
a planar substrate having a front surface and a back surface;
a light emitting portion for each pixel, disposed on the front surface of the substrate;
an encapsulating layer disposed over the light emitting portion and on the front surface of the substrate, the encapsulating layer having a front surface and a back surface, said encapsulating layer having an encapsulant thickness T; and
a microlens for each pixel, having a radius of curvature R, disposed on the front surface of the encapsulating layer such that its centre of curvature is within the encapsulating layer,
   wherein the radius of curvature R and the encapsulant thickness T are such that R=xT, where x has a value in the range from 0.2 to 0.8.

Preferably, the lens is centred over the light emitting portion of the OLED, i.e. the multi-layer sandwich, in order to ensure isotropic emission from the light coupling layer. However, for applications where anisotropic emission may be desired, for example to increase the brightness of an LEP display when viewed from a particular angle other than normal to the plane of the light coupling layer, the lens may be positioned off-centre with respect to the light emitting portion.

In order to provide an advantage in terms of improved light emission (luminous intensity) from the light coupling layer, i.e. from the substrate according to the first aspect and from the encapsulating layer according to the second aspect, and thus a discernable increase in brightness to a viewer, the light coupling layer and the microlenses should be so arranged that the centre of curvature of the microlenses is within the light coupling layer, and should be so configured in relative size that the radius of curvature R of the lenses and the thickness T of the light coupling layer satisfy the equation R=xT, wherein x has a value in the range from 0.2 to 0.8. For example, x is in the range from 0.4 to 0.6, preferably in the range from 0.45 to 0.6, more preferably in the range from 0.47 to 0.55, more preferably still x is in the range from 0.49 to 0.55, and most preferably x is 0.5.

Preferably, each microlens is disposed on the front surface of the light coupling layer so as to extend across the full width of each pixel. Consequently, if the pixel array has a regular pixel pitch P, and the center of curvature of each lens is at a distance D from the front surface of the light coupling layer, it follows that D²+P²/2=R². Accordingly, D=R√(1−1/(2y²)) if y is defined as R/P. Preferably, D=zT wherein z=0.2-08, preferably 0.3-0.7, more preferably 0.4-0.6 and most preferably about 0.5.

The maximum pitch P is when the microlens is a hemisphere disposed on the front surface of the light coupling layer (i.e. D=0). Thus, the maximum pitch P will be 2R. In the preferred case that x=0.5, whereby R=T/2, the maximum pitch P will be 2×(T/2)=T, i.e. the pixel pitch P will be the same as the thickness T. In the case where x=0.45, the maximum pitch P will be 2×(0.45T)=0.9T.

The pixel pitch P can be decreased whilst still satisfying the criterion that R=xT by moving the centre of curvature of the lens a distance D below the front surface of the light coupling layer, always provided that D<R.

The pixel pitch P and thickness T can be varied within the constraints dictated by the relationships between R, T and P explained above. For example, the pixel pitch P is suitably in the range from 0.1 to 0.5 mm, preferably in the range from 0.2 to 0.4 mm. The thickness T is suitably in the range from 0.2 to <1.50 mm, preferably in the range from 0.3 to 1.0 mm. However, preferably the thickness T and the pixel pitch P are such that T=aP, where a has a value in the range from 0.4 to 2.5, more preferably in the range from 0.5 to 1.5.

In order to describe the relative sizes of the light emitting portions with respect to their associated pixels size, it is convenient to define the aperture ratio AR as the area of the light emitting portion as a fraction of the pixel area. Assuming square pixels of pitch P, the pixel area is P². Assuming square light emitting portions of length/width A, having an area A², the aperture ratio (%) is given by (A²/P²)×100%. In terms of efficiency, smaller aperture ratios are preferred, for example an aperture ratio AR in the range from 4 to 49%, i.e. A is in the range from 0.2P to 0.7P, in particular an aperture ratio AR in the range from 4 to 25%, i.e. A is in the range from 0.2P to 0.5P. However, in display devices a balance must be struck between efficiency and the lifetime of the device, and in practice, therefore, the use of larger aperture ratios may be preferred in order to allow larger pixels to be driven at a lower current for the same light output, so as to obtain a longer lifetime.

The microlens preferably is configured as a planoconvex lens, for example a hemisphere in the case that R=P/2, disposed on or formed in the light coupling layer. Alternatively, the microlens is configured as a Fresnel lens of equivalent focal length. The lenses may be applied to or formed in the light coupling layer by suitable methods in known manner, for example by adhering the lenses to the light coupling layer, by directly embossing the light coupling layer to form the appropriately shaped lenses, or by adhering an embossed laminate having the lenses formed therein to the light coupling layer.

The light coupling layer is preferably of a material having a refractive index in the range from 1.40 to 1.60, more preferably in the range from 1.49 to 1.53. Accordingly, the planar substrate according to the first aspect or the encapsulating layer according to the second aspect preferably has a refractive index in the range from 1.40 to 1.60, more preferably in the range from 1.49 to 1.53. The light coupling layer preferably is of glass or polycarbonate.

The planar substrate according to the second aspect is for example of glass or polycarbonate, more preferably glass or polycarbonate having a refractive index in the range from 1.40 to 1.60, more preferably in the range from 1.49 to 1.53.

The microlens may be of the same or a different material from the light coupling layer, but preferably is of a material that has the same or similar index of refraction. Accordingly, we prefer that the microlens is of the same material as the light coupling layer. The microlens material is preferably glass or polycarbonate, more preferably glass or polycarbonate having a refractive index in the range from 1.40 to 1.60, more preferably in the range from 1.49 to 1.53.

In a preferred embodiment of the first aspect, the OLED device is a bottom emitter comprising:
a planar glass substrate of refractive index in the range from 1.49 to 1.53 having a front surface and a back surface, said glass substrate having a thickness T=0.7 mm and defining an array of pixels having a pixel pitch P=0.3 mm;
a light emitting portion for each pixel, disposed on the back surface of the substrate;
   a glass microlens of refractive index in the range from 1.49 to 1.53 having a radius of curvature R=0.35 mm disposed on the front surface of the glass substrate, whereby its centre of curvature is at a distance D=0.316 mm from the front surface of the glass substrate, and R=0.5T.

The microlenses can be attached to or formed in the substrate (in the case of a bottom emitter) or in the encapsulating layer (in the case of a top emitter) by appropriate techniques as are known in the art. Where a micro-structured film is applied to a substrate, the techniques used should ensure accurate placement of the micro-structured films, and avoid such issues as film stretch. Micro-optical techniques which involve the embossing of micro-lenses in situ may be used, if appropriate.

Through the use microlenses in devices according to the invention, increases in luminous intensity (brightness) could be achieved, for example by factors as large as 2 to 3 for substrates of thickness T=2.5P.

The invention will be further illustrated by the following non-limiting examples:

### EXAMPLES

### Experimental

Optical modelling was performed using micro-lenses on OLED devices, to show the effect of changing the substrate size, the emitting area and the use of varying radii of curvature of the micro-lenses on the light output. The modelling was performed using proprietary software Trace-pro®, a non-sequential ray-tracing program useful for optical analysis of light rays through solid models. The program allows the source material to be defined in terms of its optical properties, i.e. scattering and surface texture as well as complex refractive indices, and calculates the propagation of multiple rays of an initial light flux through the material. As the rays propagate through the model, portions of the flux of each ray are allocated for absorption, specular reflection and transmission, and scattering. The flux of each ray is reduced at each ray-surface interaction, until it falls below a set threshold or is fully absorbed at a defined target position. The program uses Monte Carlo methods to analyse the ray tracing. Such a method uses randomness to predict the ray emission location and directions, in contrast to using sequential methods.

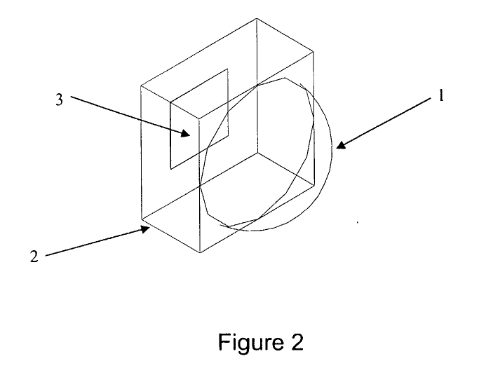

FIG. 2 shows a diagram of the simulated OLED device used in this model.

As can be seen, only the polymer layer and the glass substrate were used to simulate the OLED device. Regarding the other layers in the device, based on results from a previous study, the specular back reflection from a metal cathode at normal incidence is taken as 50%, and therefore in the model the back surface of the polymer layer is a mirror with 50% specular reflection and 50% absorption, with the latter added so as to include the absorption effects from the other device layers. Thus, losses from these other layers were included but were not specifically studied. The edges of the substrate were defined as perfect absorbers, in order to exclude cross talk originating from internal reflections of the light from the substrate edges and from the light entering from adjacent pixels. Thus, the present model is based on the calculated contributions from the emitting area and not the reflections.

The design parameters in the simulated model were:

Pixel Pitch (P.P)

Glass Substrate Thickness

Emitting Area

Radius of Curvature of the Lens attached to the front surface of the display.

Table 1 gives details of the OLED device dimensions of the simulated devices. Each parameter is a multiple of the P.P value. Typically, OLED devices have a pixel pitch of <0.3 mm. For the modelling purposes, the P.P value was defined to be 1.

In each model the emitting area was defined to be square and the length of a side of this square was varied from 20% to 90% of the P.P, i.e an Aperture Ratio (AR) range of 4% to 81%. Both the substrate thickness and lens radius of curvature were varied from 0.5×P.P to 4.0×P.P.

FIG. 2 shows a device structure with the lens 1 of radius of curvature 0.5×P.P attached to the front of the substrate 2. The emitting area 3 is shown as a square having sides of a length 0.5×P.P.

TABLE 1

| | Length (mm) | Width (mm) | Thickness (mm) |
|---|---|---|---|
| Glass Substrate | 1 × P.P | 1 × P.P | (0.5, 1.5, 2.5, 4) × P.P |
| Polymer Layer | 1 × P.P | 1 × P.P | 0.001 |
| Emitting Layer | (0.2, 0.35, 0.5, | (0.2, 0.35, 0.5, | 0.0005 |
| | 0.7, 0.9) × P.P | 0.7, 0.9) × P.P | |

A yellow electroluminescent polymer was used and the glass substrate was defined as being sodalime glass, and corresponding complex refractive index data were used in the model based on data known from ellipsometer measurements. The optical flux emitted out of the device hit a defined target of a size determined by the criterion that it had to capture at least 99% of the emission that leaves the pixel.

The values for the maximum optical flux and luminous intensity were calculated for the simulated devices, both without the lens and with the lens. The improvement observed by the introduction of the lens was then tabulated and plotted as a contour plot against emission length and radius of curvature of lens for each substrate thickness modelled. All charts plot the ratio of the optical output with the lens to that without.

Results:

Luminous Intensity:

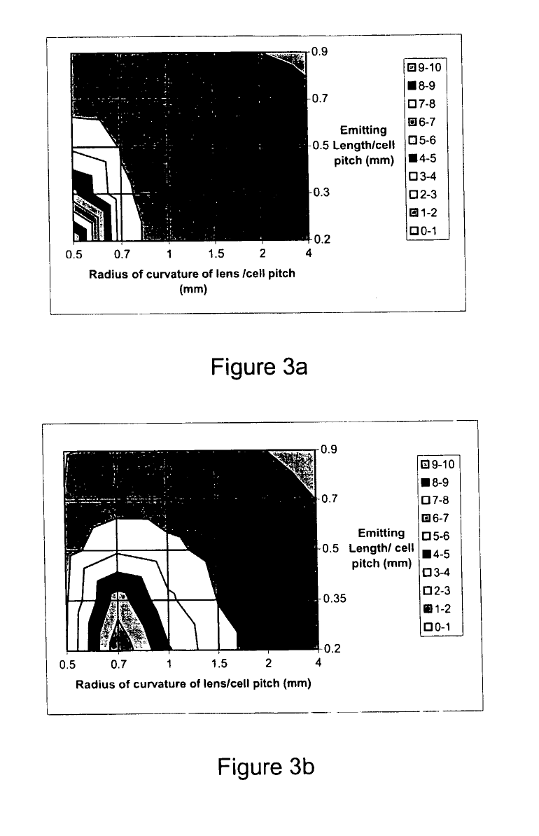

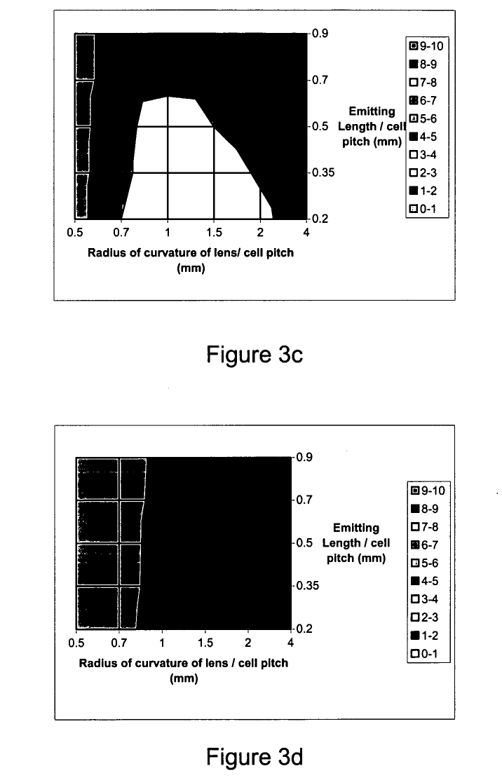

FIGS. 3a, 3b, 3c and 3d show the results for a range of emitting lengths and radii of lens curvature for 0.5×, 1.5×, 2.5× and 4.0×P.P substrate thicknesses, respectively, in candela plots for each of the simulated LEP devices, as plotted from the calculations done by the ray-tracer program. The luminous intensity values were calculated at the same defined target as for the previous calculations for the optical flux. The increase in luminous intensity was plotted for each of the substrate thicknesses against the radius of curvature of the lens and the emitting length of the electroluminescent polymer.

The results obtained for the 0.5×P.P substrate thickness and the 1.5×P.P substrate thickness are shown in FIGS. 3a and 3b respectively. It may be seen that the use of these thinner substrates would allow a much narrower viewing angle and thus a far larger increase in the luminous intensity value. To compare what the effect would be if thicker substrates were used, FIGS. 3c and 3d show the increases with the 2.5×P.P and the 4.0×P.P substrate. The results show that a smaller increase in the luminous intensity is observed with these substrate thicknesses.

Thus, the results show that increases in luminous intensity (brightness) could be achieved by factors as large as 2-3 for substrates of thickness (2.5×P.P) mm. As the pixel pitch is typically <0.3 mm, this would mean a thickness of <0.8 mm.

1. An OLED device comprising:
at least one pixel;
a planar light coupling layer having a front surface and a back surface, said layer having a thickness T,
a light emitting portion for each pixel, disposed on the back surface of the light coupling layer; and
a microlens for each pixel, having a radius of curvature R, disposed on the front surface of the light coupling layer such that its center of curvature is within the light coupling layer,
wherein the radius of curvature R and the thickness T are such that R=xT, where x has a value in the range from 0.2 to 0.8.

2. An OLED device according to claim 1, being a bottom emitter in which the light coupling layer is a planar substrate, and comprising:
a planar substrate having a front surface and a back surface, said substrate having a substrate thickness T;
a light emitting portion for each pixel, disposed on the back surface of the substrate; and
a microlens for each pixel, having a radius of curvature R, disposed on the front surface of the substrate such that its center of curvature is within the substrate, wherein the radius of curvature R and the substrate thickness T are such that R=xT.

3. An OLED device according to claim 1, being a top emitter in which the light coupling layer is an encapsulating layer, and comprising:
a planar substrate having a front surface and a back surface;
a light emitting portion for each pixel, disposed on the front surface of the substrate;
an encapsulating layer disposed over the light emitting portion and on the front surface of the substrate, the encapsulating layer having a front surface and a back surface, said encapsulating layer having an encapsulant thickness T; and
a microlens for each pixel, having a radius of curvature R, disposed on the front surface of the encapsulating layer such that its center of curvature is within the encapsulating layer.

4. An OLED device according to claim 1, wherein the microlens is centered over the light emitting portion.

5. An OLED device according to claim 1, wherein x is in the range from 0.4 to 0.6.

6. An OLED device according to claim 5, wherein x is in the range from 0.45 to 0.6.

7. An OLED device according to claim 6, wherein x is in the range from 0.47 to 0.55.

8. An OLED device according to claim 7, wherein x is in the range from 0.49 to 0.55.

9. An OLED device according to claim 8, wherein x is 0.5.

10. An OLED device according to claim 1, wherein the microlens is a planoconvex lens.

11. An OLED device according to claim 1, wherein the microlens is a Fresnel lens.

12. An OLED device according to claim 1, wherein the light coupling layer is of a material having a refractive index in the range from 1.40 to 1.60.

13. An OLED device according to claim 1, wherein the microlens is of a material having a refractive index in the range from 1.40 to 1.60.

14. An OLED device according to claim 1, wherein the material of at least one of the light coupling layer and the microlens is glass or polycarbonate.

15. An OLED device according to claim 14, wherein the material is glass having a refractive index in the range from 1.49 to 1.53.

16. An OLED device according to claim 1, wherein the light coupling layer defines an array of pixels having a pixel pitch P, and each microlens is disposed on the front surface of the light coupling layer such that its center of curvature within the light coupling layer is at, or at a distance D from, the front surface of the light coupling layer such that D=zT wherein D=R√(1−1/(2y²)); y is defined by RIP; and z=0.2-0.8.

17. An OLED device according to claim 16, wherein the thickness T and the pixel pitch P are such that T=aP, where a has a value in the range from 0.4 to 2.5.

18. An OLED device according to claim 17, wherein the pixel pitch P is in the range from 0.2 to 0.4 mm and the thickness T is in the range from 0.3 to 1.0 mm.
